(19) United States
(12) Patent Application Publication
(10) Pub. No.: US 2005/0285002 A1
(43) Pub. Date: Dec. 29, 2005

(54) Apparatus and method for mounting a fixture

(76) Inventor: Frank Blateri, Coppell, TX (US)

Correspondence Address: HAYNES AND BOONE, LLP, 901 MAIN STREET, SUITE 3100, DALLAS, TX, 75202, US

(21) Appl. No.: 10/880,252

(22) Filed: Jun. 29, 2004

(51) Int. Cl. B42F 13/00

(52) U.S. Cl. 248/343

(57) ABSTRACT

Apparatus and method for mounting a downrod, and therefore a fixture, to a ceiling, according to which an adapter is disposed in a bore of a hanger ball that is connected to the ceiling, a portion of the downrod is disposed in a bore of the adapter and the downrod is between the hanging ball and the fixture.

### BACKGROUND

This invention relates to an apparatus for mounting a fixture to a ceiling utilizing a downrod extending between the fixture and the ceiling.

Various ceiling-mountable fixtures, such as fans, lights (semiflushes, chandeliers, pedants, etc,) are usually connected to an electrical box, terminal, or the like, at the ceiling. When it is desired to lower the fixture from the ceiling, a downrod is often connected between the electrical box, or terminal and the fixture. To this end, a hanger ball has been used that is mounted to the ceiling and has an inner bore that receives the upper end portion of the downrod in a manner so that the downrod can be hung from the hanger ball.

The diameter of the bore of the hanger ball should correspond to the outer diameter of the downrod so that the end portion of the downrod can fit in the bore with minimum clearance to insure a stable connection. However, the diameters of the downrods often vary, creating a compatibility problem with the hanger ball, and vice versa.

Therefore, what is needed is an adapter to enable a downrod to be connected to a hanger ball in a stable manner despite variances in the diameter of the downrod and the bore of the hanger ball.

### BRIEF DESCRIPTION OF THE DRAWINGS

FIG. 1 is an elevational view of an assembly according to an embodiment of the present invention.

FIG. 2 is an exploded view of the assembly of FIG. 1.

FIG. 3 is a sectional view of the assembly of the embodiment of FIG. 1 in an assembled condition.

FIG. 4 is a sectional view taken along the line 4-4 of FIG. 2.

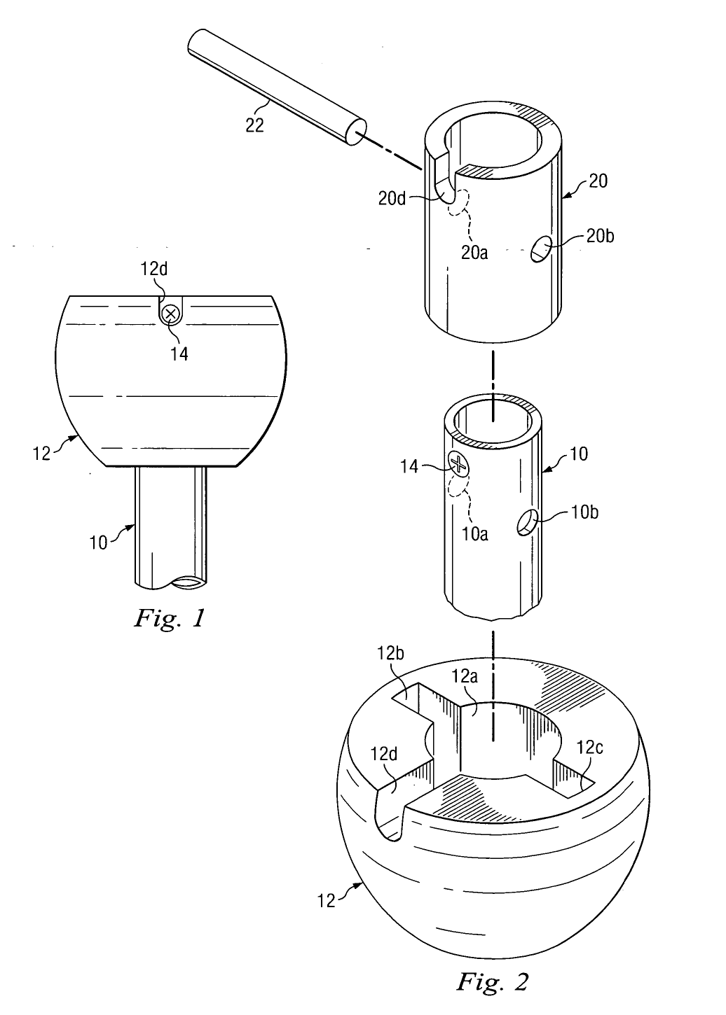

### DETAILED DESCRIPTION

Referring to the drawings, the reference 10 refers, in general, to a downrod having an upper end portion, as viewed in the drawing, extending in, and connected to, a hanger ball 12 in a manner to be explained. It is understood that the hanger ball 12 is designed to be connected to a ceiling via a conventional mounting bracket, or the like (now shown). The other end portion of the downrod 10 is adapted for connection, in a conventional manner, to a fixture, such as a ceiling fan, light fixture, or the like, (not shown) in a spaced relation to the ceiling.

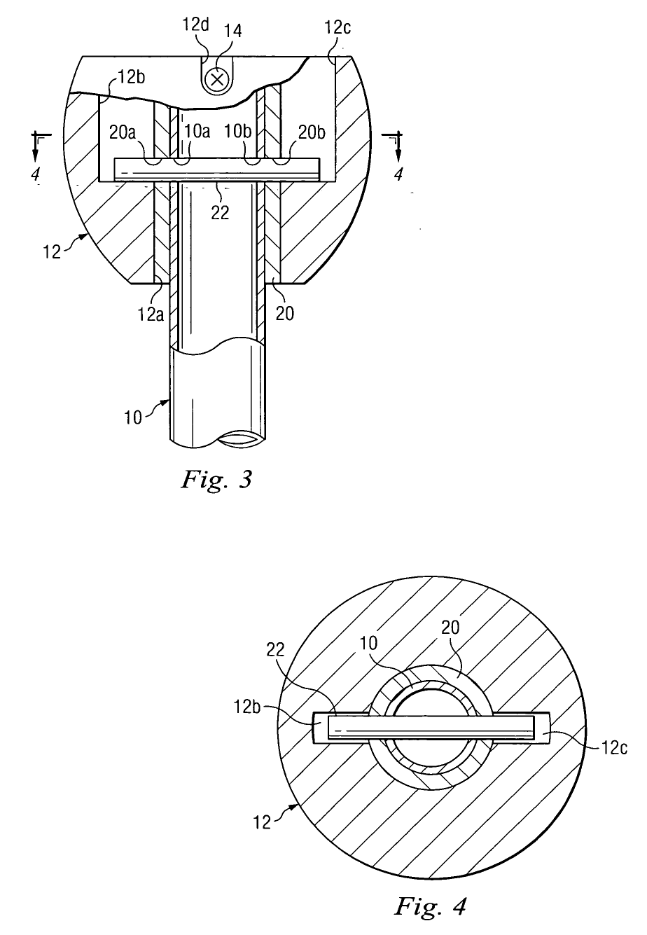

The downrod 10 is tubular and has two aligned, diametrically opposed, openings 10a and 10b (FIG. 3) extending through its wall near its upper end and transverse to the longitudinal axis of the downrod. A ground screw 14 extends through an opening in the upper end portion of the downrod 10 for the purpose of enabling a ground conductor from the ceiling and/or the fixture to be electrically and mechanically connected to the downrod. The remaining electrical conductors from the ceiling and/or the fixture can be threaded through the hanger ball 12 and the downrod 10, in a conventional manner.

The hanger ball 12 is spherical in shape and has an internal bore 12a. Two diametrically opposed slots 12b and 12c are formed in the hanger ball 12 that extend from the bore and from the upper end of the ball. A groove 12d is provided in the upper end portion of the hanger ball 12 to permit access to the ground screw 14.

It will be assumed that the hanger ball 12 is designed to be used with a downrod having a diameter corresponding to the diameter of its bore 12, and that the outer diameter of the downrod 10 is much less than this diameter. Hence if the downrod 10 were directly mounted in the hanger ball 12 it would create an unstable connection due to the above differences in diameters.

To enable the downrod 10 to be supported by the hanger ball 12 in a stable manner, a tubular adapter 20 is provided that extends between the outer diameter of the upper end portion of the downrod 10 and the bore 12a of the hanger ball and in a coaxial relation with the downrod and the hanger ball. The length of the adapter 20 is substantially the same as the length of the hanger ball 12, and, as better shown in FIGS. 3 and 4, the outer diameter of the adapter 20 corresponds to the diameter of the bore 12a of the hanger ball 12 so that the adapter 20 extends in the latter bore with minimum clearance. Similarly, the bore of the adapter 20 corresponds to the outer diameter of the downrod 10 so that the upper end portion of the downrod extends in the adapter 20 with minimum clearance.

The wall of the adapter 20 has two aligned, diametrically opposed, openings 20a and 20b (FIG. 3) extending therethrough and transverse to the longitudinal axis of the downrod. The openings 20a and 20b are aligned with the openings 10a and 10b in the downrod 10, and a pin 22 extends through the aligned openings. The respective end portions of the pin rest on the shoulders of the hanger ball 12 formed by the slots 12b and 12c, to support, or hang, the downrod 10 from the hanger ball. The axial positions of the openings 20a and 20b in the wall of the adapter 20 relative to the depth of the slots 12b and 12c of the hanger ball 12 are such that the upper ends of the downrod 10 and the adapter 20 extend flush with the upper end of the hanger ball 12, as shown in FIG. 3, to enable the hanger ball to be mounted directly to the ceiling.

A groove 20d is provided in the upper end portion of the adapter 20 to permit access to the ground screw 14.

As a result, the upper end portion of the downrod 10 is supported along its entire length by the adapter 20, which, in turn, engages the bore 12a of the hanger ball with minimum clearance. As a result, the downrod 10 is supported by the hanger ball 12 in a very stable manner.

### Variations

It is understood that several variations may be made in the foregoing without departing from the scope of the invention. For example, the upper end portion of the downrod 12 can be externally threaded and the bore of the hanger ball 12 and the adapter 20 can be internally threaded. Moreover, the grounding screw 14 could be eliminated.

Although only a few exemplary embodiments have been described in detail above, those skilled in the art will readily appreciate that many other variations and modifications are possible in the exemplary embodiment without materially departing from the novel teachings and advantages of this invention. Accordingly, all such variations and modifications are intended to be included within the scope of this invention as defined in the following claims. In the claims, means-plus-function clauses are intended to cover the structures described herein as performing the recited function and not only structural equivalents, but also equivalent structures.

1. Apparatus for mounting a downrod to a ceiling, the apparatus comprising:
a hanger ball adapted for connection to the ceiling and having an internal bore;
an adapter extending in the bore of the hanger ball and having a bore;
a downrod having at least a portion extending in the bore of the adapter; and
means connecting the downrod to the hanger ball.

2. The apparatus of claim 1 wherein the means comprises a pin extending through aligned openings in the downrod and the adapter and supported by the hanger ball.

3. The apparatus of claim 2 wherein the pin and the aligned openings extend transverse to the longitudinal axes of the bores.

4. The apparatus of claim 2 wherein two diametrically opposed slots are formed in the hanger bore to define two shoulders on which the corresponding end portions of the pin rests.

5. The apparatus of claim 1 wherein the downrod and the bores of the adapter and the hanger ball extend in a coaxial relationship.

6. The apparatus of claim 1 wherein the means connects the adapter to the downrod and the hanger rod.

7. The apparatus of claim 1 wherein the adapter extends in the bore of the hanger rod with minimum clearance and the downrod extends in the bore of the adapter with minimum clearance.

8. Apparatus for mounting a fixture to a ceiling including a hanger ball adapted for connection to the ceiling and having an internal bore and a downrod having an outer diameter less than that of the bore; wherein the improvement comprises an adapter extending in the bore of the hanger ball and having a bore that receives the downrod, and means connecting the downrod to the hanger ball.

9. The improvement of claim 8 wherein the means comprises a pin extending through aligned openings in the downrod and the adapter and supported by the hanger ball.

10. The improvement of claim 9 wherein the pin and the aligned openings extend transverse to the longitudinal axes of the bores.

11. The improvement of claim 9 wherein two diametrically opposed slots are formed in the hanger bore to define two shoulders on which the corresponding end portions of the pin rests.

12. The improvement of claim 8 wherein the downrod and the bores of the adapter and the hanger ball extend in a coaxial relationship.

13. The apparatus of claim 8 wherein the means connects the adapter to the downrod and the hanger rod.

14. The apparatus of claim 8 wherein the adapter extends in the bore of the hanger rod with minimum clearance and the downrod extends in the bore of the adapter with minimum clearance.

15. The apparatus of claim 8 wherein the upper end portion of the downrod extends in the adapter and the lower end of the downrod is adapted for connection to the fixture.

16. A method for mounting a downrod to a ceiling, the method comprising:
connecting a hanger ball to the ceiling;
disposing an adapter in a bore of the hanger ball;
disposing a portion of the downrod in a bore in the adapter; and
connecting the downrod and the hanging ball.

17. The method of claim 16 wherein the step of connecting comprises inserting a pin through aligned openings in the downrod and the adapter and supporting the pin by the hanger ball.

18. The method of claim 17 wherein the pin and the aligned openings extend transverse to the longitudinal axes of the bores.

19. The method of claim 17 wherein the step of connecting comprises forming two diametrically opposed shoulders on the hanger bar and resting the corresponding end portions of the pin on the shoulder.

20. The method of claim 16 wherein the downrod and the bores of the adapter and the hanger ball extend in a coaxial relationship.

21. The method of claim 16 further comprising connecting the adapter to the downrod and the hanger rod.

22. The method of claim 16 wherein the adapter extends in the bore of the hanger rod with minimum clearance and the downrod extends in the bore of the adapter with minimum clearance.

23. The method of claim 16 wherein the upper end portion of the downrod extends in the adapter and further comprising connecting the lower end of the downrod to the fixture.
